(19) United States
(12) Patent Application Publication
(10) Pub. No.: US 2021/0280036 A1
(43) Pub. Date: Sep. 9, 2021

(54) EMERGENCY APPLIANCE TERMINATION SWITCH

(71) Applicant: Instant Care, Inc., Escondido, CA (US)

(72) Inventors: Richard Allen Darling, Poway, CA (US); Fong-Min Chang, Diamond Bar, CA (US); Chih-Cheng Tai, Campbell, CA (US)

(73) Assignee: Instant Care, Inc., Escondido, CA (US)

(21) Appl. No.: 17/192,154

(22) Filed: Mar. 4, 2021

Related U.S. Application Data
(60) Provisional application No. 62/985,319, filed on Mar. 4, 2020.
(60) Provisional application No. 62/985,322, filed on Mar. 5, 2020.
(60) Provisional application No. 62/985,323, filed on Mar. 5, 2020.

(51) Int. Cl. G08B 21/04; H04W 4/90

(52) U.S. Cl. CPC G08B 21/0446; H04W 4/90

(57) ABSTRACT

Devices for and methods of reducing the environmental sounds (e.g., television and radio systems) when communication is critical (e.g., during an emergency call). By providing remote access to power and audio controls of a television system, it allows a remote responding operator that is calling into a home to quickly take control of an emergency situation and get the user the help that they desperately needed. The devices and methods gain control of the volume or power of a system competing for the hearing level that is required to communicate during an emergency event.

### CROSS-REFERENCE TO RELATED APPLICATIONS

This application claims priority from U.S. Provisional Patent Application Ser. No. 62/985,319, filed Mar. 4, 2020 and entitled “Emergency Appliance Termination Switch,” U.S. Provisional Patent Application Ser. No. 62/985,322, filed Mar. 5, 2020 and entitled “HEARING AID WITH FALL DETECTION,” and U.S. Provisional Patent Application Ser. No. 62/985,323, filed Mar. 5, 2020 and entitled “WIRELESS APPLIANCE REMOTE WITH ALTERNATE SIGNAL TRANSMISSION,” which are hereby incorporated herein by reference in their entirety for all purposes.

### FIELD OF INVENTION

The present invention relates to a small electronic device that is connected between a television monitor and an AC (alternating current) outlet. Specifically, the present invention relates to integrating a receiver and microprocessor into the electronic device that plugs into an AC outlet to control power On-and-Off, and or audio On-and-Off either locally at the device location or remotely by a 3^{rd} party distal to the device location during an emergency situation.

### BACKGROUND OF THE INVENTION

In today's rapidly aging world we are see a growing number of our country's population becoming 65 or older. It is estimated that the senior population will grow by an average of 2.3 million people per year until the year 2030. With this accelerated growth there are obvious concerns regarding the elderly's ability to maintain an independent quality of life in the comfort of their own homes. As technology advances there have been many new products designed to help aid in independent senior living. Devices called Personal Emergency Response Systems (PERS) are offered to seniors as a way to insure 24 hour, 7 day per week personal safety monitoring in the event of an unforeseen accident or health emergency. The systems can be triggered by methods of manually pressing a button on the actual console itself or it can be triggered by using a wireless transmitter.

While these systems are incredibly valuable there are certain aspects that limit their usefulness at times. One such limit is the volume level that these systems can produce. Studies have documented that seniors consume on average 5+ hours of television viewing per day. In addition to the audio level limitations of the emergency response systems very often the senior users have decreased hearing capabilities causing them to increase the volume on their television systems. During an emergency event where a personal emergency system is activated an operator will try to communicate through the system with the individual. Because of the overwhelming volume on the television set the operator will struggle to hear or understand what has taken place, who the person is oar what type of care is needed.

### SUMMARY OF THE INVENTION

The environmental sounds can be one of the significant factors that interferes the conversation of the emergency calls. For this reason. it is paramount that the operator have a method to quickly and efficiently muting, reducing volume, or cutting power to the television set so that the emergency can be addressed rapidly and accurately.

Therefore there is a need to provide some form. of remote control access of a media appliance or system from a remote location. This access will allow an emergency operator to provide faster, more accurate care.

Typical exiting media remotes that are used to control appliances such as televisions only offer control of said appliances. It is for this reason that there is a need for implementing a universal wireless media remote that contains a separate transmission capability designed to wirelessly trigger emergency systems, such as PERS systems, security systems or any other life safety type system.

The present disclosure provides an advanced small electronic device that plugs into an AC outlet to control power on-and-off, and audio on-and-off either locally at the device location or remotely by a 3^{rd} party distal to the device location.

The device disclosed herein allows a user to take advantage of enhanced lifesaving technology by reducing the outside influences of day to day background noise produced by appliances, such as television systems when communication is critical. By providing remote access to power and audio controls of a television system, it allows a responding operator that is calling into a home to quickly take control of an emergency situation and get the user the help they desperately need. Gaining control of the volume or power of a system competing for the hearing level that is required to communicate during an emergency event does not currently exist and is greatly needed.

A method of and device for environmental interferences reduction when providing an emergency assistance are provided. In some embodiments, the environmental interferences includes sounds and noises. In some embodiments, the reduction including reducing, removing, and/or disabling sources that generates the environmental interferences, such as loud TV or audio. In an example, an appliance (e.g., a TV) is powered off. In another example, a noise cancellation device is used to reduce the background or environmental sounds. Any environmental interferences that can be reduced, eliminated, removed, and/or inhibited are within the scope of the present disclosure.

### BRIEF DESCRIPTION OF THE DRAWINGS

FIG. 1 illustrates an emergency event assistance requesting method 100 in accordance with some embodiments.

FIG. 2 illustrates another emergency event assistance requesting method 200 in accordance with some embodiments.

FIG. 3 illustrates a small electronic kill switch 310 in accordance with some embodiments.

FIG. 4 illustrates another emergency event assistance requesting method 400 in accordance with some embodiments.

### DETAILED DESCRIPTION AND EMBODIMENTS

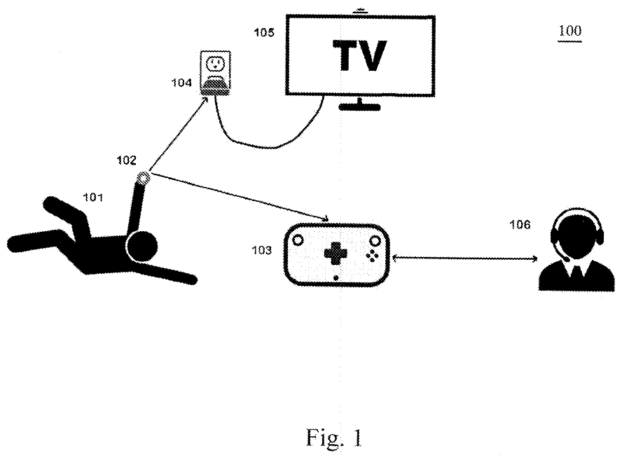

FIG. 1 illustrates an emergency event assistance requesting method 100 in accordance with some embodiments. FIG. 1 illustrates an emergency event where a user (e.g., victim) (101) has fallen to the ground and is holding a small wireless transmitter (102) in their hand. Upon pressing the transmitter button, the transmitter (102) sends a signal to activate a Personal Emergency Response console (103) while at the same time sending a signal to a small electronic kill switch (104). In some embodiments, the small electronic kill switch (104) has male prongs for an AC outlet and a female port to plug in the power cord of a television set (105). General, power is passed through the kill switch (104) and allows the television set (105) to receive power. When a signal is sent to the kill switch (104), the kill switch (104) shuts off power to an active television set (105), which deactivate, pause, or reduce the function of the TV, including reducing sounds and volume. terminating power, and/or reducing power. In some embodiments, the kill switch (104) changes the current function or status of the TV, such as sending a signal to sound alarms.

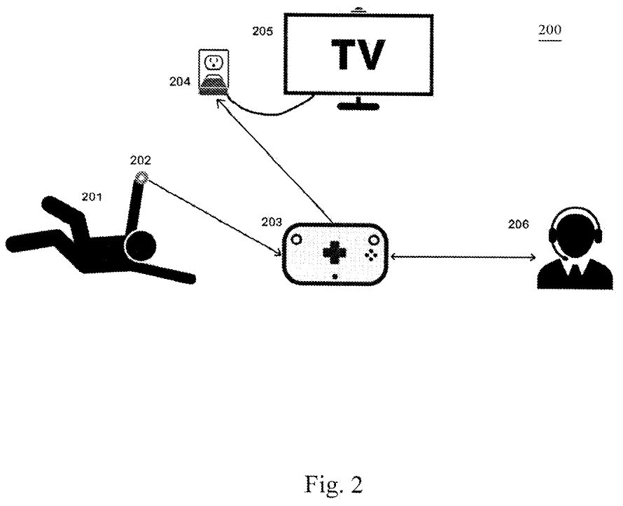

FIG. 2 illustrates another emergency event assistance requesting method 200 in accordance with some embodiments. FIG. 2 illustrates an emergency event where a user (e.g., victim) (201) has fallen to the ground and is holding a small wireless transmitter (202) in their hand. Upon pressing the transmitter button, the transmitter sends a signal to activate a Personal Emergency Response console (203) causing the emergency console to dial to a 3^{rd} party monitoring center operator (206). The operator (206) then opens a line of communication through the emergency console, which makes the emergency console (203) to transmit an audio tone to be received by a small electronic kill switch (204). The small electronic kill switch (204) is plugged in between the AC outlet and the television set (205). Power is passed through the kill switch (204) and allows the Television set (205) to receive power. When a signal from the operator (206) or from the emergency console (203) is received by the kill switch (204), the kill switch (204) shuts off power to an active television set (205). The signal mentioned above includes a signal of cutting off TV power or a signal of reducing environmental sounds. In some embodiments, the kill switch (204) changes the current function or status of the TV, such as sending a signal to sound alarms.

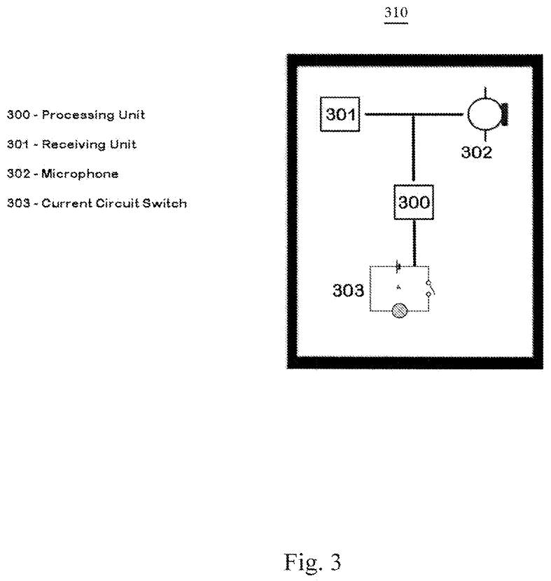

FIG. 3 illustrates a small electronic kill switch (310) in accordance with some embodiments. FIG. 3 illustrates a small electronic kill switch, which contains a processor (300) for processing data, a receiving unit (301) that receives an incoming wireless activation signal, a microphone (302) to receive incoming sounds, and a current circuit switch (303) that when activated by the processor (300) either from an incoming signal from the receiving unit (301) or the microphone (302) activates the current circuit switch (303) to close the switch thus cutting power that passes through the small electronic kill switch to the television set or any other appliance plugged into it. The small electronic kill switch (310) can be the kill switch (104) of FIG. 1 and kill switch (204) of FIG. 2.

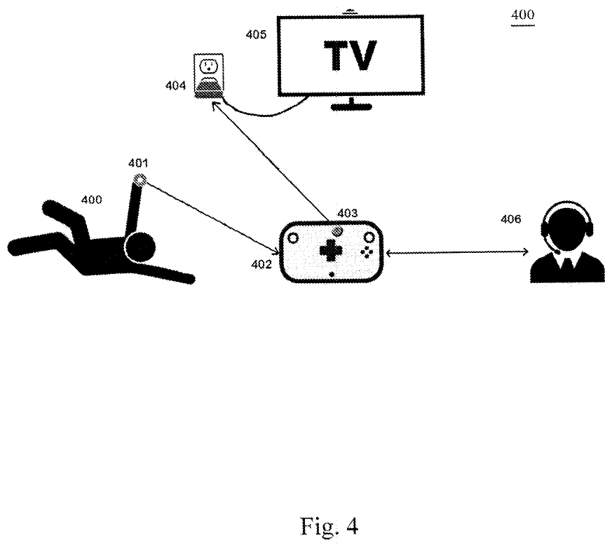

FIG. 4 illustrates another emergency event assistance requesting method 400 in accordance with some embodiments. FIG. 4 illustrates an emergency event where a user (e.g., a victim) (400) has fallen to the ground and is holding a small wireless transmitter (401) in his/her hand. Upon pressing the transmitter button, the transmitter sends a signal to activate a Personal Emergency Response console (402). Upon activation the consoles, the console (402) transmits an outbound call to an emergency response call center (406) while at the same time a small vibration sensor containing a RF transmitter (403) is activated when the system communicates an emergency tone. A RF signal is then transmitted to a small electronic kill switch (404) that has male prongs for an AC outlet and a female port to plug in the power cord of a television set (405). Power is passed through the kill switch (404) and allows the television set (405) to receive power. In some embodiments, the small vibration sensor containing a RF transmitter (403) has a sensor (e.g., a vibrational sensor), which is configured to sense a triggered motion generated by the console (402), such as vibrations, dial tones, a mode of communications, and any other motion that signify that the console (402) make a status change from a purely monitoring mode.

The present disclosure provides a method of controlling the power to a television set using a small electronic kill switch device that is plugged into a standard AC outlet. In some embodiments, the device is designed to work in combination with a personal emergency response system. When integrated into a personal emergency response system network, the device advantageously enhances communication capabilities and quality between a system user in need and an operator at a responding call center.

The electronic kill switch device is be able to learn to communicate with a wide range of monitored receive systems, such as but not limited to personal emergency response systems, residential security systems, commercial security systems, property management systems, and networked camera systems.

In one aspect, the present disclosure provides a kill switch designed into a small electronic device such as a smart plug, or other similar device or apparatus in sizes, constructions, or functions. In some embodiments, the small electronic device comprises a processor, a receiving unit, a microphone and a circuit switch. The device can be plugged into a standard AC outlet and provide a female connector to allow for a television by methods of power outlet pass-through.

It is a still further feature to allow the microphone feature to listen for tones transmitted through the emergency response console from an operator as an audio method for triggering the closing of the power circuit switch thus cutting power to the television set that is plugged into it.

In one embodiment, the system utilizes DTMF (Dual Tone-Multi Frequency) tones sent by an operator through the emergency response system to activate the circuit in the kill switch to terminate power to an appliance that has been plugged into the kill switch.

In yet another embodiment, the system utilizes high frequency audio tones sent by an operator through the emergency response system to activate the circuit in the kill switch to terminate power to an appliance that has been plugged into the kill switch.

By providing this added control system feature into a personal emergency response communication network, it provides a higher level of emergency response, and create greater product acceptance and retention by the end users using systems incorporating this feature.

It is a further feature of the disclosure to provide an appliance kill switch or similar type device that is simple to manufacture.

In yet another embodiment, the electronic kill switch device is a smart plug. In another embodiment the small electronic device is a power plug with pass-through power.

In another embodiment, the small electronic device is a smart home device, such as an Amazon Echo or similar.

In yet another embodiment, the electronic kill switch device is integrated with a voice activated receiver unit that wakes up by a voice command and activate the circuit switch on a second voice command.

The kill switch disclosed herein can be a power circuit switch that when a activation signal is received, the switch opens or closes causing the appliance plugged into it to lose power.

In yet another embodiment, the electronic kill switch device contains a learn button that can be pressed to place the unit in a learning mode, so that it could learn in/coupled to a wireless transmitter.

In another embodiment, the electronic kill switch device accepts SMS signals from a 3^{rd} party distal to the users location and trigger the circuit switch to the on or off position, thus killing or initiating power to any appliance plugged in.

In another embodiment, the electronic kill switch device accepts WiFi signals from a 3^{rd} party distal to the users location and trigger the circuit switch to the on or off position, thus killing or initiating power to any appliance plugged in.

In another embodiment, that electronic kill switch device receives ultrasonic tones to wake the device and or receive operational commands.

In addition to a television set as described above, any appliance that requires the power is be cut or disconnected, or to be powered on to further the quality of assistance rendering/providing are within the scope of the present disclosure.

The electronic kill switch device can be made in many forms and is utilized as part of multi-tiered approach for monitoring emergency and non-emergency conditions of individuals that have a higher than normal need for monitored help.

The devise disclosed here is able to be integrated with different sensors that serves as a “mesh” of technology to cover and report incidents.

In some embodiments, the electronic kill switch device is powered by direct AC power. In some embodiments, the electronic kill switch device is powered by one or more replaceable batteries. In some embodiments, the electronic kill switch device utilize one or more rechargeable batteries.

In some embodiments, the small electronic kill switch device provides audio tones as a confirmation to a user when it is operating under an error condition. In some embodiments, the electronic kill switch device provides visual confirmation of supervisory issues such as a system error by using a small LED or other visual indicator.

In some embodiments, the electronic kill switch device has the ability to learn known transmit protocols of monitored systems that communicate with a 3^{rd} party monitoring facility located distal to the monitored system.

In yet another embodiment, the small electronic device transmits a unique protocol designed to communicate with a specific security system. In another embodiment, the electronic kill switch device has the ability to learn multiple security system protocols.

In some embodiments, the small electronic device receives signals from a wide range of wireless protocols that include but are not limited to Sub-Gigabyte RF, Bluetooth, ZigBee, ZWAVE.

In another embodiment, the small electronic device transmits a signal to a cellular phone causing the phone to dial out to a preset 3^{rd} party distal to the remote controller location.

In another embodiment, the device incorporates a vibration sensor as a method of transmitting a signal to the kill switch to cut power to a system that is in full operation.

In yet another embodiment, the receiving unit designed to kill the power to an appliance is also able to be used to activate a variety of devices that include, but not limited to appliances, lights, communications systems, mobile phones, tablets, sirens, door locks, window locks, garage doors, or utility valves.

In another embodiment, a network of sensors such as the ones described herein apply a system or organization to the sensor data received by the algorithm from the network of sensors so that the data may be ranked using a preset library of criteria or by using a continuing learned library of criteria through methods such as Artificial intelligence (AI) to help confirm or reject the incoming data as it relates to a true human fall condition.

In another embodiment, a network of sensors such as the ones described herein apply to a system or organization of the sensor data received by the algorithm from the network of sensors so that the data may be ranked using a preset library of criteria or by using a continuing learned library of criteria through methods such as Artificial Intelligence (AI) to help confirm or reject the incoming data as it relates to a true human fall condition. The data from each sensor in the network of sensors can receive a varying level of priority or ranking based on, but not limited to such factors as what type of sensor is reporting, how many sensors are reporting, data received from each reporting sensor (e.g., impact vs twist), each sensors location, etc. to help filter out false data or filter through positive data to more accurately determine true human fall events.

In an exemplary embodiment, a Smart IR Remote Assistance Hub (hereinafter “SIRRAH”) is provided, which can be an IR blaster. SIRRAH contains an emergency assistance signal monitoring sensor. When SIRRAH detects a triggered event or emergency assistance request signal, SIRRAH functions to reduce the environmental interferences so that the communication for help is clearer, such as reducing TV or radio sounds. In some embodiments, SIRRAH automatically perform the motion of environmental interference reduction or removal. In some other embodiments, a remote SIRRAH sends a wired/wireless signal to command appliance or electronics in reducing or eliminating the environmental interferences. In some embodiments, SIRRAH receives WIFI signal whiles control appliance using IR signal. In some other embodiments, SIRRAH receives IR signal and sends out control signals using WIFI. A person of ordinary skill in the art appreciates that other methods of communications are able to be used in various embodiments.

In some embodiments, SIRRAH has universally compatibility, which makes SIRRAH support most of home appliance with IR frequency (e.g., at 38 KHz (NO, RF)), including air conditioner, TV STB, TV Box, DVD, projector, fans. In some embodiments, SIRRAH supports DIY learning. SIRRAH learns the control codes from IR devices, and re-blast it out on demand.

In some embodiments, SIRRAH works with AMAZON ALEXA, GOOGLE HOME, and IFTTT. SIRRAH allows user-initiated control of reducing environmental interference by allow user to use voice control.

In utilization, the device and method provided herein are used to reduce the background noises during an emergency assistance communication.

In operation, a device is configured to cut off power supplied to the appliance with sensing the occurrence of an emergency assistance.

What is claimed is:

1. A method of enhancing quality of communication during an emergency assisting request comprising:
a) sensing an occurrence of the emergency assisting request; and
b) reducing an environmental sound interference during the emergency assisting request by reducing an environmental sound generated by an electronic device.

2. The method of claim 1, wherein the electronic device is powered by AC power via an emergency assisting request sensing device.

3. The method of claim 2, further comprising sensing a triggered emergency assisting request by using the emergency assisting request sensing device.

4. The method of claim 3, wherein the triggered emergency assisting request is generated by a wearable device.

5. The method of claim 3, wherein the wearable device comprises a fall sensor.

6. The method of claim 3, wherein the triggered emergency assisting request comprises a signal of a detected human fall event.

7. The method of claim 1, wherein the electronic device comprises a video and audio player.

8. The method of claim 3, wherein the video and audio player comprise a TV.

9. An emergency assisting device for terminating power from an appliance comprising:
a) a receiving unit configured to receive a wireless signal of an urgent assisting request;
b) a processor for processing the received wireless signal urgent assisting request; and
c) a circuit switch configured to reduce an environmental interference when the processor received wireless signal urgent assisting request.

10. The emergency assisting device of claim 9, wherein the wireless signal of an urgent assisting request comprises a triggered fall sensor signal.

11. The emergency assisting device of claim 9, wherein the environmental interference is generated from the appliance.

12. The emergency assisting device of claim 11, wherein the appliance comprises a video or audio player.

13. The emergency assisting device of claim 9, wherein the receiving unit comprises a microphone for receiving an audio signal.

14. The emergency assisting device of claim 9, wherein the audio signal comprises DTMF tones.

15. The emergency assisting device of claim 9, wherein the receiving unit comprises a RF transceiver.

16. The emergency assisting device of claim 9, wherein the emergency assisting device is electrically coupled between the appliance and a power supply and is configured to control a supply of power to the appliance.

17. The emergency assisting device of claim 9, wherein the emergency assisting device is configured to learn command signals transmitted from a universal remote control.

18. The emergency assisting device of claim 9, wherein the emergency assisting device is configured to learn command signals transmitted from a transmitter programmed to a personal emergency response console.

19. The emergency assisting device of claim 9, wherein the emergency assisting device receives audio commands through a personal emergency response console from a remote controlling device.

20. The emergency assisting device of claim 9, wherein the emergency assisting device receives audio commands through a security system from a remote controlling device.

21. The emergency assisting device of claim 20, wherein the security system comprises a monitored system located in a residential home.

22. The emergency assisting device of claim 20, wherein the security system comprises a monitored system located in a commercial building.

23. An apparatus for terminating power to an appliance that is activated when a signal is sent to a personal emergency response system comprising:
a) a receiver configured to receive a wireless signal of an assistance needed event;
b) a processor configured to process the wireless signal; and
c) an environmental sound regulator configured to regulate power supplied to the appliance that is electrically coupled with the apparatus.

24. The apparatus of claim 23, further comprising a microphone configured to receive an audible or ultrasonic audio signal.

25. The apparatus of claim 23, wherein the ultrasonic audio signal comprises an operational command.

26. The apparatus of claim 23, further comprising a vibrational sensor that sends a wireless signal to the apparatus for terminating power to the appliance that is connected to the appliance.

27. The apparatus of claim 23, wherein the environmental sound regulator stops a power supply to the appliance when the processor detects the wireless signal of an assistance needed event.
